(19) United States
(12) Patent Application Publication
(10) Pub. No.: US 2014/0160478 A1
(43) Pub. Date: Jun. 12, 2014

(54) METHOD AND SYSTEM FOR CORRECTING MEASUREMENT DIFFERENCE OF TRANSMITTANCE FREQUENCY SPECTRUM OF COLOR FILTER

(71) Applicant: SHENZHEN CHINA STAR OPTOELECTRONICS TECHNOLOGY CO., LTD, Shenzhen (CN)

(72) Inventors: Wende Huang, Shenzhen (CN); Qiaoyun Ye, Shenzhen (CN); Yueyan Zhang, Shenzhen (CN)

(73) Assignee: SHENZHEN CHINA STAR OPTOELECTRONICS TECHNOLOGY CO., LTD., Shenzhen Guangdong (CN)

(21) Appl. No.: 13/811,390

(22) PCT Filed: Dec. 20, 2012
(86) PCT No.: PCT/CN2012/086993

§ 371 Date: Jan. 22, 2013

(30) Foreign Application Priority Data
Dec. 10, 2012 (CN) 201210528069.2

(51) Int. Cl. G01N 21/25

(52) U.S. Cl. CPC G01N 21/255
USPC 356/416

(57) ABSTRACT

The present disclosure provides a method for correcting a measurement deviation of a transmittance frequency spectrum of a color filter. With the standard measuring data of transmittance frequency spectrum of the color filter, based on the deviation between the standard measuring data and the instantaneous measuring data of the transmittance frequency spectrum, the measurement of the transmittance frequency spectrum can be corrected automatically, which reduces the time of the transferring of the glass, analysis of the data, and manual correcting, reduces the labor, improves the utilization rate and productivity of the machine. The present disclosure further provides a system correcting a measurement deviation of transmittance frequency spectrum of a color filter.

### BACKGROUND

1. Technical Field

The present disclosure relates to liquid crystal displaying technologies, and particularly, to a system and a method for correcting a measurement deviation of a transmittance frequency spectrum of a color filter.

2. Description of Related Art

Due to advantages including small size, light weight, excellent image quality, low power consumption, low service life, digitalization, and no radiation, TFT-LCD (Thin Film Transistor Liquid Crystal Display) has be commonly used in different kinds of large, medium, and small size of products, which almost cover all the main electronic products in the present information society such as televisions, computers, mobile phones, GPS (Global positioning system), vehicle displays, and public displays. TFT-LCD is the combination of the semiconductor technology and the liquid crystal displaying technology, and the manufacture of a CF (color filter) is the hardest part among the whole manufacture of the TFT-LCD. In the manufacturing process of the CF, the quality of the CF can be indicated by the chromaticity characteristic value of a film layer of the CF. The chromaticity of the CF is generally measured by a micro spectrometer (chromometer). The measuring process of the chromaticity is shown in FIG. 1. The service lifetime of a halogen lamp of the chromometer is about 1500 hours, which is about two months, or the lamp is replaced when being abnormally attenuated or burned down. After the lamp is replaced, due to the difference between the lamps, the chart of the light intensity of the signal obtained in the fourth step (as shown in FIG. 1) is greatly changed, which results in a differential of transmittance frequency spectrum calculated in the fifth step and further results in the change of the chromaticity characteristic value in the sixth step which may reach a maximum value as 1% (the change should be controlled less than 0.9% according to the product specification). At present, by measuring the CF respectively using the broken lamp and new lamp and comparing the two measuring results, the difference between the lamps can be corrected manually. However, the daily measuring deviation caused by the attenuation of the lamp needs to be corrected according to the measuring result of the measuring of the same glass substrate everyday, which is time consuming and affects the productivity. Additionally, the differences need to be corrected one by one manually.

### SUMMARY

The present disclosure provides a method for correcting a measurement deviation of a transmittance spectrum of a color filter.

The present disclosure further provides a system for correcting a measurement deviation of a transmittance spectrum of a color filter.

The method for correcting a measurement deviation of a transmittance frequency spectrum of a color filter includes: step A, catching at least one standard color filter each which has normal chromaticity characteristic values; step B, measuring the transmittance frequency spectrum of the standard color filter automatically to obtain standard measuring data of the transmittance frequency spectrum of the standard color filter; step C, judging whether measurement correction needs to be started or not; step D, if the measurement correction needs to be started, measuring the transmittance frequency spectrum of the color filter automatically to obtain instantaneous measuring date of the standard color filter; step E, calculating a deviation between the instantaneous measuring data and the standard measuring data of the transmittance frequency spectrum; and step F, performing the measurement correction to a measuring unit according to the calculated deviation.

Preferably, the method further includes: presetting a correction time point; and judging whether the correction needs to be started or not by analyzing whether the correction time point has been reached or not.

Preferably, the method further includes: detecting a correction command; and determining that the correction needs to be started after the correction command is detected.

Preferably, the method further includes: presetting a larger threshold value and a smaller threshold value; and judging whether the correction can be performed automatically or not by analyzing whether the calculated deviation ranges between the larger threshold value and the smaller threshold value or not; and if the correction can be performed automatically, performing the step F.

Preferably, the method further includes: if the calculated deviation is greater than or equal to the larger threshold value, outputting abnormality warning information.

The system for correcting a measurement deviation of transmittance frequency spectrum of a color filter includes:

a standard measuring database module for catching at least one standard color filter each which has normal chromaticity characteristic values and thereafter measuring the transmittance frequency spectrum of the standard color filter automatically to obtain standard measuring data of the transmittance frequency spectrum of the standard color filter;

a correction analyzing module for judging whether a measurement correction needs to be started or not, measuring the transmittance frequency spectrum of the standard color filter automatically to obtain instantaneous measuring data of the transmittance frequency spectrum of the standard color filter if the measurement correction needs to be started, and calculating a deviation between the instantaneous measuring data and the standard measuring data of the transmittance frequency spectrum; and

a correction processing module for performing the measurement correction to a measuring unit according to the calculated deviation.

Preferably, the correction analyzing module is further used for: presetting a larger threshold value and a smaller threshold value; and judging whether the automatic correction can be performed or not by analyzing whether the calculated deviation ranges between the larger threshold value and the smaller threshold value or not.

Preferably, the correction analyzing module is further used for: detecting a correction command; and determining that the correction needs to be started after the correction command is detected.

Preferably, the correction analyzing module is further used for: presetting a larger threshold value and a smaller threshold value; and judging whether the correction can be performed automatically or not by analyzing whether the calculated deviation ranges between the larger threshold value and the smaller threshold value or not.

Preferably, the correction processing module is further used for: outputting abnormality warning information if the calculated deviation is greater than or equal to the larger threshold value.

With the standard measuring data of transmittance frequency spectrum of the color filter, based on the deviation between the standard measuring data and the instantaneous measuring data of the transmittance frequency spectrum, the measurement of the transmittance frequency spectrum can be corrected automatically, which reduces the time of the transferring of the glass, analysis of the data, and manual correcting, reduces the labor, and improves the utilization rate and productivity of the machine.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a structural diagram of a system for correcting a measurement deviation of a transmittance frequency spectrum of a color filter in accordance with an embodiment of the present disclosure in running;

FIG. 2 is a flow chart showing the process for measuring a chromaticity performed by a measuring unit;

FIG. 3 is a functional block diagram of the system for correcting a measurement deviation of a transmittance frequency spectrum of a color filter in accordance with an embodiment of the present disclosure; and

FIG. 4 is a flow chart of a method for correcting a measurement deviation of a transmittance frequency spectrum of a color filter in accordance with an embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

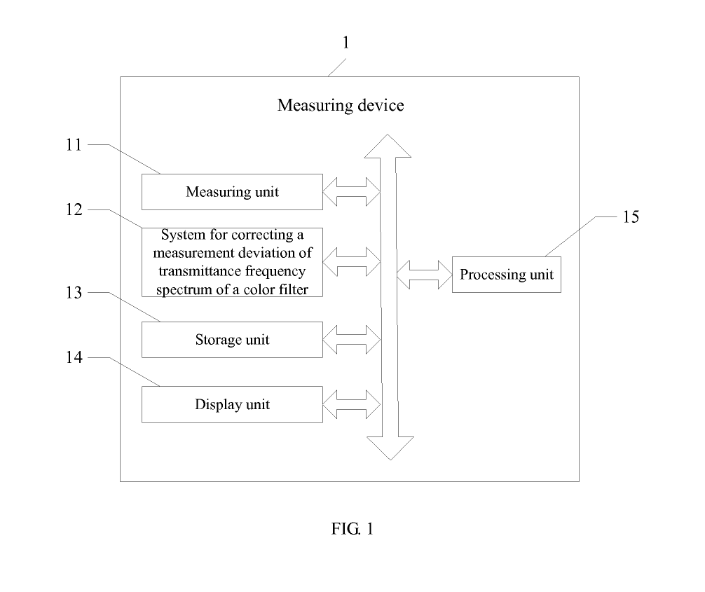

Referring to FIG. 1, which is a structural diagram of a system for correcting a measurement deviation of a transmittance frequency spectrum of a color filter in accordance with an embodiment of the present disclosure in running. The system 12 for correcting a measurement deviation of a transmittance frequency spectrum of a color filter runs in a measuring device 1. The measuring device 1 includes a measuring unit 11, a storage unit 12, a display unit 14, and a processor 15. The measuring device 1 is capable of measuring a transmittance frequency spectrum of the color filter (CF) via the measuring unit 11 thereof and calculating chromaticity characteristic values of the color filter according to the measured transmittance frequency spectrum.

The storage unit 13 is used for storing the system 12 for correcting a measurement deviation of a transmittance frequency spectrum of a color filter and the running data of the system 12.

The storage unit 13 is further used for storing the running data of the measuring unit 11.

The display unit 14 is used for providing a human-computer interacting interface which allows a user to input commands and for outputting responding data to the input commands from the measuring device 1. In the embodiment, the human-computer interacting interface includes but not limited to an operation interface of the measuring unit 11 and an operation interface of the system 12 for correcting a measurement deviation of a transmittance frequency spectrum of a color filter.

The processor 15 calls and executes the system 12 for correcting a measurement deviation of a transmittance frequency spectrum of a color filter, thereby correcting a measurement deviation of the transmittance frequency spectrum of the color filter automatically.

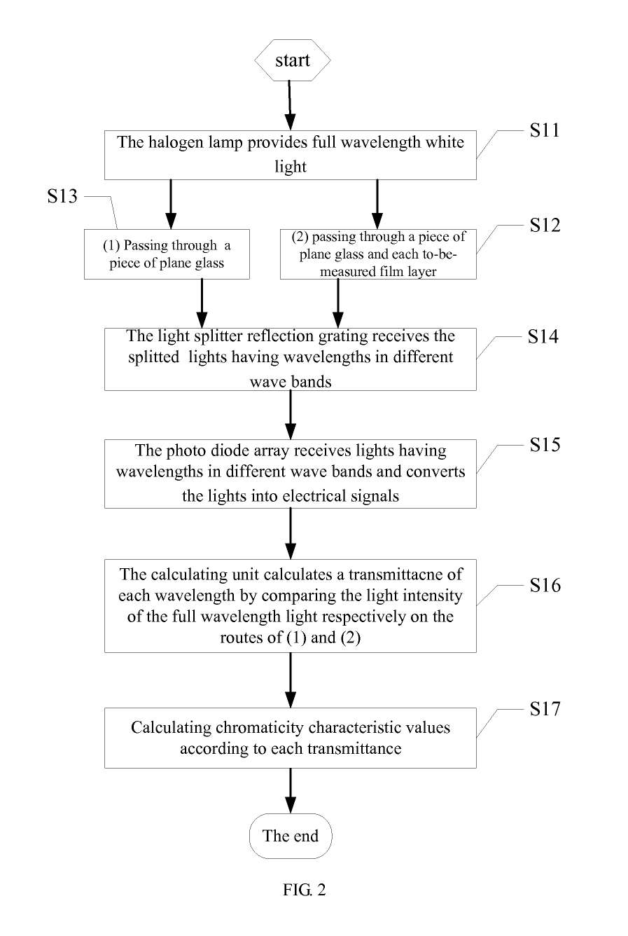

As shown in FIG. 2, which is a flow chart showing the process for measuring chromaticity performed by the measuring unit 11 of FIG. 1. The measuring unit 11 includes a halogen lamp, a light splitter reflection grating, a photo diode array, and a calculating unit. The structural diagram of the measuring unit 11 is not shown in the drawings.

Step S11, the halogen lamp provides full wavelength white light, and thereafter step S12 and step S13 are performed.

Step S12, passing the full wavelength white light through a piece of mother glass to generate a transmitting light beam on a first route.

Step S13, passing the full wavelength white light through a piece of mother glass and each film layer (BM, R, G, B, ITO) required for the color filter to generate transmitting light beam on a second route;

Step S14, the light splitter reflection grating receives the transmitting light beams on the first and second routes and splits the transmitting light beams one the first and second routes into lights in different wave bands.

Step S15, the photo diode array receives the lights in different wave bands and converts the lights into electrical signals corresponding to light intensities to obtain the electrical signals corresponding to the light intensities of the lights in different wave bands of the transmitting light beams on the first and second routes.

Step S16, the calculating unit calculates a transmittance (transmittance frequency spectrum) of the color filter by comparing the obtained electrical signals corresponding to the light intensities of the lights in different wave bands of the transmitting light beams on the first and second routes.

Step S17, the calculating unit calculates chromaticity coordinates, namely the chromaticity characteristic values according to the calculated transmittance frequency spectrum and according to special calculating formulas. In the embodiment, the special calculating formulas include:

$$X = K * {\sum }_{380}^{780} {P}_{λ} * \overline{{x}_{λ}} * {ρ}_{λ} * {Δ}_{λ}$$

$$Y = K * {\sum }_{380}^{780} {P}_{λ} * \overline{{y}_{λ}} * {ρ}_{λ} * {Δ}_{λ}$$

$$Z = K * {\sum }_{380}^{780} {P}_{λ} * \overline{{z}_{λ}} * {ρ}_{λ} * {Δ}_{λ}$$

$$x = \frac{X}{X + Y + Z}$$

$$y = \frac{Y}{X + Y + Z}$$

$$Y = Y .$$

Wherein K=10⁻⁶ , P_{λ} represents splitting light distributions of a standard light source, x̅_̅{̅λ̅}̅, y̅_̅{̅λ̅}̅, and z̅_̅{̅λ̅}̅ represent spectrum stimulus values, ρ_{λ} represents a measured relative transmittance of a wavelength which is a variable, namely a measuring value, Δ_{λ} represents an integral wavelength interval (generally being equal to 1), and x, y, and Y represent the final chromaticity characteristic values.

In other embodiments, the special calculating formulas can be any other suitable formulas used for calculating the chromaticity.

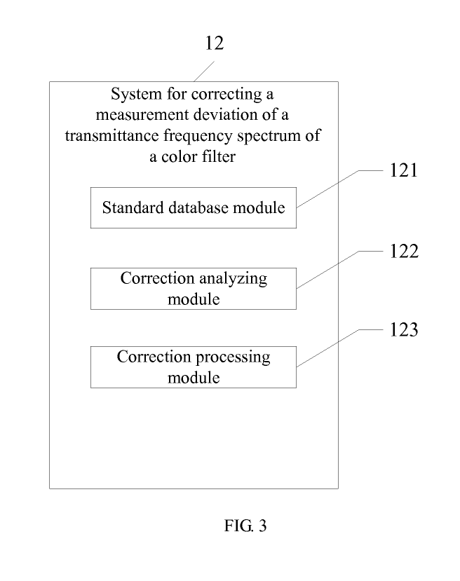

Referring to FIG. 3, which is functional block diagram of the system for correcting a measurement deviation of a transmittance frequency spectrum of a color filter in accordance with an embodiment of the present disclosure. The system 12 for correcting a measurement deviation of a transmittance frequency spectrum of a color filter includes a standard measuring database module 121, a correction analyzing module 122, and a correction processing module 123.

The standard measuring database module 121 is used for catching at least one standard color filter (having each film layer required for a color filter) each which has normal chromaticity characteristic values after the measuring device 1 is assembled and debugged, controlling the measuring unit 11 to automatically measure the transmittance frequency spectrum of the standard color filter according to manufacturing requirements of the color filter to obtain standard measuring data of the transmittance frequency spectrum of the standard color filter, and saving the obtained standard measuring data of the transmittance frequency spectrum as correction reference data. In the embodiment, the number of the standard color filter is two, one of the standard color filter is used as a correction standard color filter, and the other one is used as a second determination standard color filter or a spare standard color filter. In other embodiments of the present disclosure, the number of the standard color filter may be one or three which allows for replacement of the standard color filter in the following process.

The correction analyzing module 122 is used for judging whether a measurement correction needs to be started or not. If the measurement correction needs to be started, the correction analyzing module 122 controls the measuring unit 11 to automatically measure the transmittance frequency spectrum of the standard color filter according to the manufacturing requirements of the color filter to obtain instantaneous measuring data of the transmittance frequency spectrum of the standard color filter, calculates a deviation between the instantaneous measuring date and the saved standard measuring data of the transmittance frequency spectrum, and judges whether the correction can be performed automatically or not according to the calculated deviation.

In the embodiment, the correction analyzing module 122 presets a correction time point and two threshold values (that is, a larger threshold value B and a smaller threshold value b). The correction analyzing module 122 judges whether the correction needs to be started or not by determining whether the correction time point has been reached or not, and judges whether the correction can be performed automatically or not by determining whether the calculated deviation ranges between the larger threshold value and the smaller threshold value or not. The correction analyzing module 122 is further used for detecting a correction command (can be an operation command input by users) and determining that the correction needs to be started after the correction command is detected. For example, after the halogen lamp of the measuring unit 11 is replaced, the correction command is transmitted to the correction analyzing module 122.

The correction processing module 123 is used for performing the measurement correction to the measuring unit 11 according to the calculated deviation if the correction can be started automatically and performing corresponding operation if the correction cannot be started automatically. In the embodiment, the correction processing module 123 outputs abnormality warning information if the calculated deviation is equal to or greater than the larger threshold value. Or, the correction processing module 123 does not perform the measurement correction to the measuring unit 11 if the calculated deviation is less than the smaller threshold value.

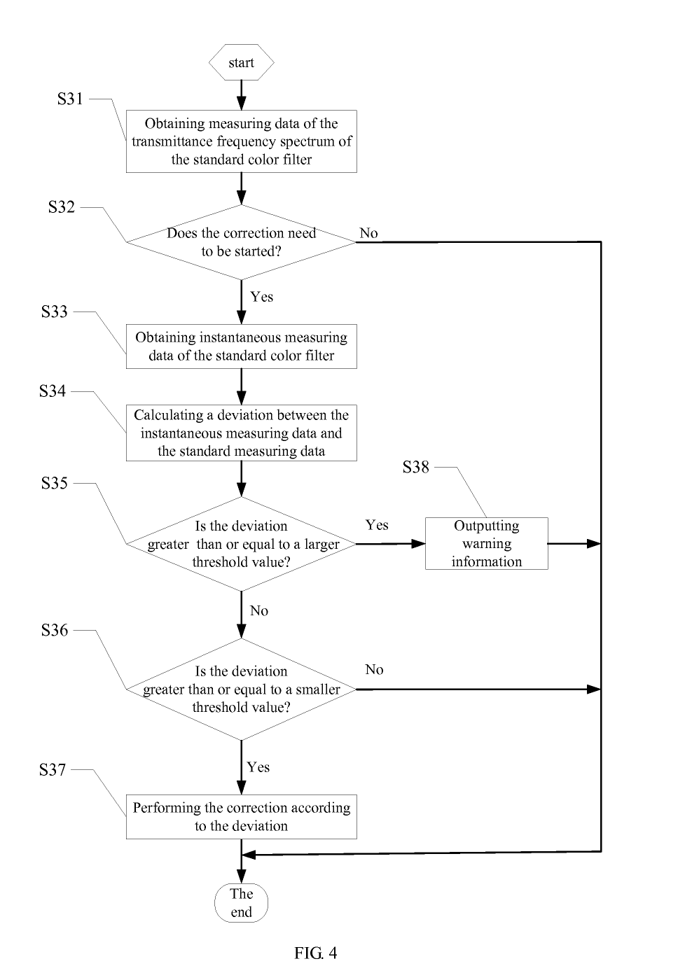

Referring to FIG. 4, which is a flow chart of a method for correcting a measurement deviation of a transmittance frequency spectrum of a color filter in accordance with an embodiment of the present disclosure.

It is noted that the flow chart shown in FIG. 4 is illustratively only, those skilled in the art of the field of the present disclosure should note that changes may be made in detail, especially in matters of shape, size, and arrangement of parts within the principles of the present embodiments to the full extent of the following embodiments:

catching at least one standard color filter each which has normal chromaticity characteristic values; controlling the measuring unit 11 to measure the transmittance frequency spectrum of the standard color filter to obtain the standard measuring data of the transmittance frequency spectrum of the standard color filter; saving the obtained standard measuring data of the transmittance frequency spectrum as the correction reference data; judging whether the measurement correction needs to be started or not; controlling the measuring unit 11 to measure the transmittance frequency spectrum of the standard color filter according to the manufacturing requirements of the color filter to obtain the instantaneous measuring data of the transmittance frequency spectrum of the standard color filter; calculating the deviation between the instantaneous measuring data and the standard measuring data of the transmittance frequency spectrum; and performing the measurement correction to the measuring unit 11 according to the calculated deviation.

Step S31, the standard measuring database 11 catches the at least one standard color filter (having each film layer required for the color filter) each which has normal chromaticity characteristic values after the measuring device 1 is assembled and debugged, controls the measuring unit 11 to measure the transmittance frequency spectrum of the standard color filter according to the manufacturing requirements of the color filter to obtain the standard measuring data of the transmittance frequency spectrum of the color filter, and saves the standard measuring data of the transmittance frequency spectrum as the correction reference data.

Step S32, the correction analyzing module 122 judges whether the measurement correction needs to be started.

If the measurement correction needs to be started, step S33 is performed; otherwise the process is ended.

Step S33, the correction analyzing module 122 controls the measuring unit 11 to measure the transmittance frequency spectrum of the standard color filter automatically according to the manufacturing requirements of the color filter to obtain the instantaneous measuring data of the transmittance frequency spectrum of the standard color filter.

Step S34, the correction analyzing module 122 calculates the deviation between the instantaneous measuring data and the standard measuring data of the transmittance frequency spectrum.

Step S35, the correction analyzing module 122 judges whether the calculated deviation is greater than or equal to the larger threshold value.

If the calculated deviation is greater than the larger threshold value, step S38 is performed and the process is ended; otherwise step S36 is performed.

Step S38, the correction processing module 123 outputs the abnormality warning information and the automatic correction is finished.

Step S36, the correction analyzing module 122 judges whether the calculated deviation is greater than or equal to the smaller threshold value.

If the calculated deviation is greater than the smaller threshold value, step S37 is performed, otherwise the process is ended.

Step S37, the correction processing module 123 performs the measurement correction to the measuring unit 11 according to a special correction formula and according to the calculated deviation.

In the embodiment, the correction formula is: Mₙ=M′ₙ+Oₙ₋₁: Oₙ=Oₙ₋₁+(D−Mₙ), wherein D is a constant representing the standard measuring data of the transmittance frequency spectrum, O is the calculated deviation and O₀=0; M represents the instantaneous measuring data of the transmittance frequency spectrum, M′ represents actual measurement original value, and n represents the actual times of the correction of the measurement and n≧1.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

1. A method for correcting a measurement deviation of a transmittance frequency spectrum of a color filter, comprising:
step A, catching at least one standard color filter each which has normal chromaticity characteristic values;
step B, measuring the transmittance frequency spectrum of the standard color filter automatically to obtain standard measuring data of the transmittance frequency spectrum of the standard color filter;
step C, judging whether measurement correction needs to be started or not;
step D, if the measurement correction needs to be started, measuring the transmittance frequency spectrum of the color filter automatically to obtain instantaneous measuring date of the standard color filter;
step E, calculating a deviation between the instantaneous measuring data and the standard measuring data of the transmittance frequency spectrum; and
step F, performing the measurement correction to a measuring unit according to the calculated deviation.

2. The method as claimed in claim 1 further comprising:
presetting a larger threshold value and a smaller threshold value; and
judging whether the correction can be performed automatically or not by analyzing whether the calculated deviation ranges between the larger threshold value and the smaller threshold value or not; and
if the correction can be performed automatically, performing the step F.

3. The method as claimed in claim 2 further comprising:
if the calculated deviation is greater than or equal to the larger threshold value, outputting abnormality warning information.

4. The method as claimed in claim 1 further comprising:
presetting a correction time point; and
judging whether the correction needs to be started or not by analyzing whether the correction time point has been reached or not.

5. The method as claimed in claim 4 further comprising:
presetting a larger threshold value and a smaller threshold value; and
judging whether the correction can be performed automatically or not by judging whether the calculated deviation ranges between the larger threshold value and the smaller threshold value or not; and
if the correction can be performed, performing the step F.

6. The method as claimed in claim 5 further comprising:
if the calculated deviation is greater than or equal to the larger threshold value, outputting abnormality warning information.

7. The method as claimed in claim 1 further comprising:
detecting a correction command; and
determining that the correction needs to be started after the correction command is detected.

8. The method as claimed in claim 7 further comprising:
presetting a larger threshold value and a smaller threshold value;
judging whether the correction can be performed automatically or not by analyzing whether the calculated deviation ranges between the larger threshold value and the smaller threshold value or not; and
if the correction can be performed, performing the step F.

9. The method as claimed in claim 8 further comprising:
if the calculated deviation is greater than or equal to the larger threshold value, outputting abnormality warning information.

10. A system for correcting a measurement deviation of transmittance frequency spectrum of a color filter, comprising:
a standard measuring database module for catching at least one standard color filter each which has normal chromaticity characteristic values and thereafter measuring the transmittance frequency spectrum of the standard color filter automatically to obtain standard measuring data of the transmittance frequency spectrum of the standard color filter;
a correction analyzing module for judging whether a measurement correction needs to be started or not, measuring the transmittance frequency spectrum of the standard color filter automatically to obtain instantaneous measuring data of the transmittance frequency spectrum of the standard color filter if the measurement correction needs to be started, and calculating a deviation between the instantaneous measuring data and the standard measuring data of the transmittance frequency spectrum; and
a correction processing module for performing the measurement correction to a measuring unit according to the calculated deviation.

11. The system as claimed in claim 10, wherein the correction analyzing module is further used for:
presetting a larger threshold value and a smaller threshold value; and
judging whether the automatic correction can be performed or not by analyzing whether the calculated deviation ranges between the larger threshold value and the smaller threshold value or not.

12. The system as claimed in claim 11, wherein the correction processing module is further used for:
outputting abnormality warning information if the calculated deviation is greater than or equal to the larger threshold value.

13. The system as claimed in claim 10, wherein the correction analyzing module is further used for:
presetting a correction time point; and
judging whether the correction needs to be started or not by analyzing whether the correction time point has been reached or not.

14. The system as claimed in claim 13, wherein the correction analyzing module is further used for:
presetting a larger threshold value and a smaller threshold value; and
judging whether the correction can be performed automatically or not by analyzing whether the calculated deviation ranges between the larger threshold value and the smaller threshold value or not.

15. The system as claimed in claim 14, wherein the correction processing module is further used for:
outputting abnormality warning information if the calculated deviation is greater than or equal to the larger threshold value.

16. The system as claimed in claim 610, wherein the correction analyzing module is further used for:
detecting a correction command; and
determining that the correction needs to be started after the correction command is detected.

17. The system as claimed in claim 16, wherein the correction analyzing module is further used for:
presetting a larger threshold value and a smaller threshold value; and
judging whether the correction can be performed automatically or not by analyzing whether the calculated deviation ranges between the larger threshold value and the smaller threshold value or not.

18. The system as claimed in claim 17, wherein the correction processing module is further used for:
outputting abnormality warning information if the calculated deviation is greater than or equal to the larger threshold value.
